(19) United States
(12) Patent Application Publication
(10) Pub. No.: US 2026/0210634 A1
(43) Pub. Date: Jul. 23, 2026

(54) METHOD FOR HEATING A STEEL INTERMEDIATE STRIP WHEN PRODUCING A FLAT STEEL STRIP

(71) Applicants: Primetals Technologies Austria GmbH, Linz (AT); Primetals Technologies Germany GmbH, Erlangen (DE)

(72) Inventors: Kerstin BAUMGARTNER, Katsdorf (AT); Jakub GORYCKI, Krakow (PL); Jonas MILBREDT, Frankfurt am Main (DE); Gero SCHWARZ, Attnang (AT); Michael ZAHEDI, St. Marien (AT)

(21) Appl. No.: 19/143,136

(22) PCT Filed: Dec. 1, 2023
(86) PCT No.: PCT/EP2023/083919

§ 371 Date: Jun. 25, 2025

(30) Foreign Application Priority Data
Dec. 28, 2022 (EP) 22216967.4

(51) Int. Cl. F27B 9/36; C21D 1/42; C21D 9/60; F27B 9/28; F27B 9/40

(52) U.S. Cl. CPC F27B 9/36; C21D 1/42; C21D 9/60; F27B 9/28; F27B 9/40

(57) ABSTRACT

A method for heating, in particular reheating, an intermediate strip when producing a flat strip, wherein the intermediate strip is heated using induction module heads of induction modules of an induction furnace, in particular of a rolling mill, preferably of a steel strip production system, and the induction module heads are mechanically positioned according to at least one current parameter of the intermediate strip at/in the induction furnace.

### CROSS-REFERENCE TO RELATED APPLICATIONS

The present application is a 35 U.S.C. § 371 national stage application of International Application No. PCT/EP2023/083919, filed Dec. 1, 2023, which claims priority to European Patent Application EP 22216967, filed Dec. 28, 2022, the contents of which are incorporated herein by reference.

### FIELD OF INVENTION

The invention relates to a method for heating, in particular reheating, an intermediate strip when producing a flat strip. Furthermore, the invention relates to a system controller for an induction furnace, a rolling system or a steel strip production system, in particular for endless strip production. In addition, the invention relates to an induction furnace, a rolling system or a steel strip production system, in particular for endless strip production.

### BACKGROUND

In a steel strip production system, for example for endless strip production (ESP), an induction furnace is used in a rolling system of the steel strip production system by a casting-rolling method for reheating a (steel) intermediate strip of a (steel) flat strip to be formed. This induction furnace is located, for example, between a high reduction mill (HRM) having, for example, two to four and in particular three rolling stands, and a finishing mill (FM) having, for example, four to seven and in particular five rolling stands.

A quality of a finished flat strip depends, in addition to a plurality of other mutually influencing impact factors, on heating or on reheating of an intermediate strip in an induction furnace. In particular with thinner intermediate strips, so-called transverse field induction modules (transversal flux) of the induction furnace have become established as an efficient and therefore a suitable solution for a rolling system in a steel strip production system. The rolling system can comprise a plurality of mills analogously to the statements above here.

Furthermore, the quality of the finished flat strip depends on a uniform temperature distribution of the intermediate strip, in particular at a rear longitudinal end of the induction furnace in the production direction. The more uniform the current temperature distribution along a surface line or along a cross section in the transverse direction of the intermediate strip, the better a quality of the finished flat strip can be. The transverse direction is of course perpendicular here to the two strip edges of the intermediate strip.—It is an object of the invention to ensure correct heating, in particular correct reheating, of an intermediate strip when producing a flat strip.

EP 2 287 345 A1 teaches a method for controlling and/or regulating an induction furnace for a rolling system, wherein electrical actuation of the induction coils of an induction furnace is disclosed.

JP S62 013 526 A discloses a method for regulating the temperature of an inductively heated furnace for heating slabs using computer-based regulation.

JP 2007 237 240 A discloses a mechanical adjustment of induction coils.

### SUMMARY

The object of the invention is achieved by a method for heating, in particular reheating, an intermediate strip when producing a flat strip; by means of a system controller for an induction furnace, a rolling system or a steel strip production system, in particular for endless strip production; and by means of an induction furnace, a rolling system or a steel strip production system, in particular for endless strip production. Advantageous refinements, additional features and/or advantages of the invention result from the dependent claims and the following description.

Transverse field induction modules of an induction furnace for, for example, a rolling system of a steel strip production system are in particular installed and actuated in pairs in order to make a power introduction into the intermediate strip uniform if possible. A pair of transverse field induction modules is installed as follows here.

A first strip edge (edge area) is heatable by a closed end area of a first induction module head of a transverse field induction module and the second strip edge (edge area) is heatable by the closed end area of a second induction module head of a transverse field induction module. The same applies to the open middle areas of the transverse field induction modules; i.e. an open middle area of the induction module head of the first transverse field induction module is located with respect to an induction furnace center line diagonally in relation to the open middle area of the induction module head of the second transverse field induction module. Cf. also FIGS. 3 to 7 (closed end areas: 13, open middle areas: 14).

It was established in the course of studies of the quality of finished flat strips that at a longitudinal end of the induction furnace, which is outgoing, i.e. at the rear, in the production direction, a symmetrical temperature distribution of an intermediate strip (FIG. 2) as a precursor stage of a uniform temperature distribution, which cannot be practically configured presently in a running intermediate strip, represents a good compromise. (Such an essentially uniform temperature distribution at a strip edge is represented by the temperature distribution shown solid in FIG. 1, wherein only a single induction module head has been active here.)

It was established in the course of more extensive studies that, due to mechanical positioning of the induction module heads with respect to the induction furnace center line, actual positioning of the induction module heads at an intermediate strip running through the rolling system often deviates from intended positioning. This is the case if the intermediate strip center line does not coincide (in parallel) with the induction furnace center line. Contrary to the previous assumptions, it has been shown that such deviations in parallel in both transverse directions and angled deviations are the rule and not the exception.

It is therefore important that the induction modules are correctly positioned with respect to the intermediate strip in order to achieve a uniform temperature distribution of the intermediate strip on its surface in the transverse direction, for example imagined as a transverse line, thus also across its cross section.—In the method according to the invention, the intermediate strip is heated by induction module heads of induction modules of an induction furnace, in particular of a rolling system, preferably of a steel strip production system, in particular for endless strip production, wherein the induction module heads are mechanically positioned according to at least one current, i.e. of course also actual, parameter of the intermediate strip at/in the induction furnace.—Of course, at least one further parameter can optionally be applied for positioning the induction module heads.

According to the at least one parameter of the intermediate strip, the positioning of induction module heads of the induction furnace takes place such that at at least one position in/at the induction furnace, in the transverse direction at/in the intermediate strip with respect to the intermediate strip center line, a thermal energy distribution (for example a temperature distribution), which becomes symmetrical over time, of the running intermediate strip results. That is to say, the thermal energy distribution of the running intermediate strip is observed at this at least one position. The thermal energy distribution or a symmetry of the thermal energy distribution is independent here of deviations of the intermediate strip center line from an induction furnace center line.

According to the at least one parameter of the intermediate strip, in the chronological sequence, attempts can be made or attempts are intended to be made at the at least one position in/at the induction furnace by the positioning of induction module heads to obtain this thermal energy distribution of the intermediate strip in its preliminary symmetry or to make this preliminary symmetry more symmetrical. Furthermore, alternatively or additionally, attempts can be made or attempts are intended to be made to homogenize this thermal energy distribution of the intermediate strip in the transverse direction at/in the intermediate strip. Furthermore, alternatively or additionally, attempts can be made or attempts are intended to be made to equalize thermal energy of a strip edge of the intermediate strip to thermal energy of the intermediate strip center line.

The parameter of the intermediate strip can reflect an essentially current (actual) statement about the current (actual) intermediate strip at/in the induction furnace and/or at/in the rolling system. Furthermore, the parameter of the intermediate strip may not represent a solely general statement about the induction furnace itself and/or the rolling system itself.—In other words, for example, that the parameter of the intermediate strip does not reflect a solely local or global statement about the induction furnace itself and/or the rolling system itself. The parameter can represent a current statement about an interaction of the intermediate strip with the induction furnace itself and/or the rolling system itself. Furthermore, the parameter can represent a current statement about the intermediate strip at/in the induction furnace and/or a current statement about the intermediate strip itself.

The parameter of the intermediate strip may not reflect an exclusively geometric statement about the induction furnace itself and/or the rolling system itself or a transverse delimitation of the intermediate strip in the induction furnace itself and/or in the rolling system itself. Of course, this also applies to another type of characterization for the intermediate strip essentially exclusively by the induction furnace itself and/or the rolling system itself.—The parameter of the intermediate strip can reflect a geometrical location of the intermediate strip within the rolling system and/or the induction furnace, and/or a thermal energy distribution of the intermediate strip in the transverse direction of the intermediate strip at/in the rolling system and/or at/in the induction furnace.

It is important in this case that a distance of induction modules to a strip edge of the intermediate strip is correctly set in order to achieve, if possible, a symmetrical and possibly uniformly (similar values and/or no discontinuity point (high gradient, buckle) ) formed thermal energy distribution of the intermediate strip on its surface across its width (imagined as a width line) or across a cross section.—Actual positioning of an induction module head with respect to a strip edge or the strip edges of the intermediate strip is not known accurately enough in the prior art. The closest measuring positions for the intermediate strip are located spatially significantly upstream of and/or spatially significantly downstream of the induction furnace and/or the rolling mill.

The parameter of the intermediate strip can reflect the intermediate strip center line in the induction furnace. In this case, a different value, in particular a different current measured value, can be incorporated in the parameter of the intermediate strip. Furthermore, a current thermal energy distribution of the intermediate strip can be incorporated in the parameter of the intermediate strip. Furthermore, the parameter of the intermediate strip can essentially exclusively represent the intermediate strip center line. In addition, the intermediate strip center line can be detected by a center line detection process. Such a center line detection process operates, for example, using at least one lateral guidance roller, a center line measurement, an edge measurement, image processing, a vision device/system, etc.

The intermediate strip center line in the induction furnace can be determined from current positioning of precisely/at least one, precisely/at least two or precisely/at least four lateral guidance rollers on the intermediate strip. With the positioning of a single lateral guidance roller, together with a known width of the intermediate strip in the transverse direction, a point/section of a center line of the intermediate strip in the induction furnace is determinable at a position of the lateral guidance roller. A center line in the induction furnace is determinable in this way using (at least) two lateral guidance rollers arranged offset in the longitudinal direction of the induction furnace.

This can be expanded to lateral guidance roller pairs, wherein by way of a lateral guidance roller pair without a known width of the intermediate strip, a point/section of a center line of the intermediate strip in the induction furnace is determinable at a position of the lateral guidance roller pair. Using (at least) two lateral guidance roller pairs arranged offset in the longitudinal direction of the induction furnace, in this way a center line in the induction furnace is determinable, without a known width of the intermediate strip.

Current positioning of a lateral guidance roller can be taken/obtained from a force regulation of the lateral guidance roller. The current positioning of the lateral guidance rollers by means of force regulation is thus used to identify the intermediate strip center line. In this case, the intermediate strip center line identified via the lateral guidance rollers is passed on to a facility controller (automation) of the induction furnace. A parallel and/or an angled current offset of the intermediate strip center line in relation to the induction furnace center line can be determined from current positioning of lateral guidance rollers.

The parameter of the intermediate strip can reflect a thermal energy distribution of the intermediate strip at/in the induction furnace. In this case, a different value, in particular a different current measured value, can be incorporated in the parameter of the intermediate strip. Furthermore, a current intermediate strip center line can be incorporated in the parameter of the intermediate strip. Moreover, the parameter of the intermediate strip can essentially exclusively represent the thermal energy distribution of the intermediate strip. In addition, the thermal energy distribution of the intermediate strip can be detected by a temperature determination, in particular a temperature scanner.

The current thermal energy distribution of the intermediate strip can be determined in the transverse direction. A current trend line can then be determined from the thermal energy distribution, which reflects a current degree of symmetry of the thermal energy distribution of the intermediate strip in the transverse direction. On the basis of this current trend line, induction module heads of the induction furnace can be positioned such that the current degree of symmetry of the thermal energy distribution of the intermediate strip is made symmetrical or is at least not made asymmetrical in the transverse direction.

In this case, for example, a chronologically earlier trend line is compared with the current trend line, or the current trend line is compared with an ideal trend line such that the current trend line is to display an at least uniformly remaining symmetrical thermal energy distribution or an improved symmetry of the thermal energy distribution.—The thermal energy distribution of the intermediate strip can be determined, for example, by a temperature determination, in particular a temperature scanner, as a temperature distribution f the intermediate strip.

In embodiments, an incoming, current thermal energy distribution of the intermediate strip in the transverse direction can be determined before the actual (at/in the beginning of the induction furnace) and/or in the front (front half of the induction furnace) induction furnace. A required electrical power of the induction furnace, a required electrical power distribution within the induction furnace and/or a required setting of induction module heads in the transverse direction can be determined from this thermal energy distribution. Furthermore, the induction module heads can preferably be Supposed to be intended to be positioned initially in such a way that an asymmetry of a temperature distribution of the incoming intermediate strip which is incoming into the induction furnace is compensated. In this case, the method looks a certain time into the future and then positions induction module heads accordingly, possibly modified by the method, if this is necessary.

In embodiments, an outgoing, current thermal energy distribution of the intermediate strip in the transverse direction can be determined in the rear (rear half of the induction furnace) and/or behind the actual (in/at the end of the induction furnace) induction furnace. A current trend line can be determined from this thermal energy distribution, which reflects a current degree of symmetry of the thermal energy distribution of the intermediate strip in the transverse direction. The induction module heads can now be positioned on the basis of the trend line such that an asymmetry of a temperature distribution of the outgoing intermediate strip is compensated. In this case, an incoming, current thermal energy distribution the intermediate strip in the transverse direction can be taken into consideration. In other words, those induction module heads which are positioned above/below a colder strip edge are moved further in the direction of this strip edge.

The method can be operated such that a current trend line of a current thermal energy distribution of the intermediate strip approximates a desired (good to essentially optimal) trend line (target trend line). For this purpose, relevant induction module heads above/below the intermediate strip are positioned accordingly. The relevant trend line can be a linear, a nonlinear, a composite, etc. trend line.—The method can be designed as a control method or a regulation method (closed-loop control). The induction modules can be designed as transverse field induction modules. In other words, of course also that the induction module heads are designed as transverse field induction module heads.

The system controller according to the invention is designed such that a method according to the invention can be carried out and/or is carried out by the system controller. In this case, the system controller has a system control unit and connections required for this purpose.—The induction furnace according to the invention, the rolling system according to the invention or the steel strip production system according to the invention has a system controller according to the invention. Furthermore, a method according to the invention can be able to be carried out and/or can be carried out by the induction furnace according to the invention, the rolling system according to the invention or the steel strip production system according to the invention.

The invention is explained in more detail hereinafter on the basis of exemplary embodiments with reference to the appended schematic drawing, which is not to scale. Sections, elements, parts, units, components and/or schemes which have an identical, univocal or analogous design and/or function are identified in the description of the figures (see below), the list of reference signs, the claims and in the figures (Figs) of the drawing using the same reference signs. A possible alternative which is not explained in the description of the invention (see above), is not shown in the drawing and/or is not final, a static and/or kinematic reversal, a combination etc. to the exemplary embodiments of the invention or a component, a scheme, a unit, a part, an element or a section thereof can furthermore be inferred from the list of reference signs and/or the description of the figures.

In the invention, a feature (section, element, part, unit, component, function, dimension, etc.) can be designed as positive, i.e. present, or negative, i.e. absent. In this specification (description (description of the invention (see above), description of the figures (see below) ), list of reference signs, claims, drawing), a negative feature is not explicitly explained as a feature if value is not placed thereon according to the invention that it is absent. In other words, the actually made invention and not an invention constructed by the prior art consists of omitting this feature.

A feature of this specification can be applied not only in a specified way and/or manner, but also in another way and/or manner (isolation, merging, replacement, addition, placing alone, omitting, etc.). In particular, it is possible, on the basis of a reference sign and a feature assigned thereto or vice versa, in the description, the list of reference signs, the claims and/or the drawing, to replace, add or omit a feature in the claims and/or the description. In addition, a feature in a claim can thus be interpreted and/or specified in more detail. The features of the description are also interpretable as optional features (in view of the (initially largely unknown) prior art); i.e. each feature can be perceived as an optional, arbitrary or preferred, thus as a nonbinding, feature. It is thus possible to separate a feature, possibly including its periphery, from an exemplary embodiment, wherein this feature is then transferable to a generalized inventive concept. The absence of a feature (negative feature) in an exemplary embodiment shows that the feature is possibly optional (person skilled in the art) with respect to the invention. Furthermore, in the case of a term of species for a feature, a generic term for the feature can also be read (possibly further hierarchical division into subspecies, etc.), by which, for example in consideration of equivalence and/or equality, a generalization of the feature is possible.

### BRIEF DESCRIPTION OF THE FIGURES

In the solely exemplary and schematic figures of the drawing:

FIGS. 1 and 2 each show a temperature distribution of an intermediate strip in a steel strip production system, chronologically after reheating of the intermediate strip by a single transverse field induction module (FIG. 1) and by a plurality of transverse field induction modules installed in pairs (FIG. 2) of an induction furnace of a rolling mill,

FIGS. 3, 4 and 8 show two-dimensional, very schematic top views of prior art, wherein the induction module heads of induction modules relate to a center line of the rolling mill and a center line of the intermediate strip deviates parallel (FIG. 4) or angled (FIG. 5) from the rolling mill center line,

FIGS. 5 and 7 show two-dimensional, very schematic top views of exemplary embodiments of a first t embodiment of the invention, wherein induction module heads relate to a center line of the intermediate strip and the intermediate strip center line deviates parallel (FIG. 5) or angled (FIG. 7) from the rolling mill center line, and

FIGS. 8, 9 and 10 show the second embodiment of the invention, wherein by way of a trend line of an asymmetrical temperature distribution of the intermediate strip (FIG. 8) and corresponding positioning of induction module heads (FIG. 10), a trend line of a symmetrical temperature distribution of the intermediate strip (FIG. 9) is actuated or regulated.

### DETAILED DESCRIPTION

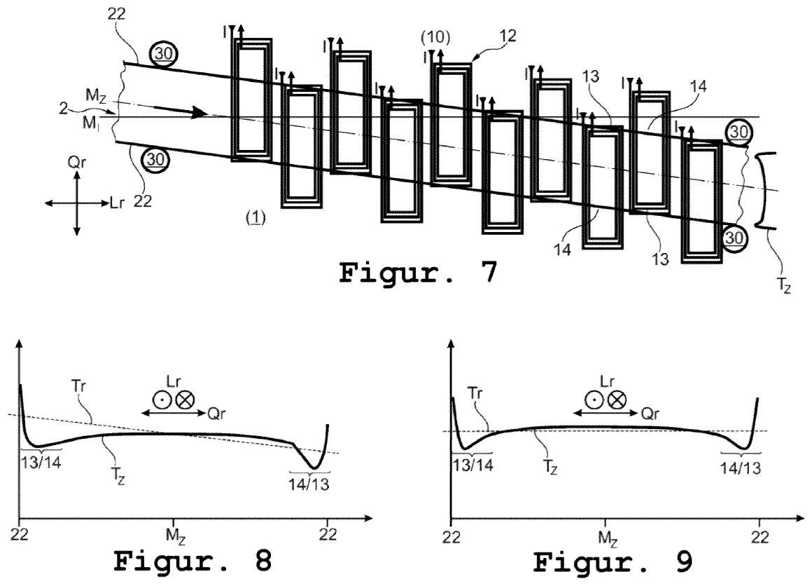

The invention is explained in more detail hereinafter on the basis of exemplary embodiments of two embodiments (first embodiment: FIGS. 5 and 7, second embodiment: FIGS. 8 to 10) of methods for heating, in particular reheating, a (steel) intermediate strip 2 in an induction furnace 1 (also referrable to as an induction heater 1) during the production of a (steel) flat strip in a rolling system of a steel strip production system, in particular for endless strip production. Although the invention is described and illustrated further in more detail by preferred exemplary embodiments, the invention is not restricted by the disclosed exemplary embodiments, but rather is of a more fundamental nature.

Other variations can be derived therefrom and/or from the above (description of the invention) without departing from the scope of protection of the invention. The invention is generally applicable for induction furnaces, in particular in the field of steel production, preferably for producing a flat strip (cf. above). Only those spatial sections of subject matter of the invention which are necessary for understanding the invention are shown in the drawing.

The explanation of the invention on the basis of the drawing refers hereinafter to a longitudinal direction Lr and a transverse direction Qr. In this case, the longitudinal direction Lr corresponds to the main extension direction of the intermediate strip 2 (and of a finished flat strip), of the induction furnace 1, of the rolling system and possibly of the steel strip production system, and the transverse direction Qr is perpendicular to the longitudinal direction Lr and is in the horizontal plane of the intermediate strip 2 (and of the finished flat strip).

An induction furnace center line M_{I} is in this case the straight line which, parallel to the longitudinal direction Lr, represents the center line M of the induction furnace 1 or of the rolling system. An intermediate strip center line M_{Z} is in this case the straight line which, primarily parallel to the longitudinal direction Lr, represents the center line M of the intermediate strip 2, in particular in the induction furnace 1 or in the rolling system. In this case, the intermediate strip center line M_{Z} can extend offset essentially in parallel or angled (small angles) with respect to the induction furnace center line M_{I}.

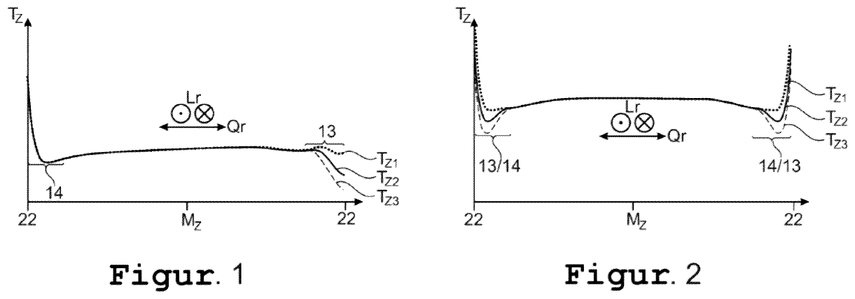

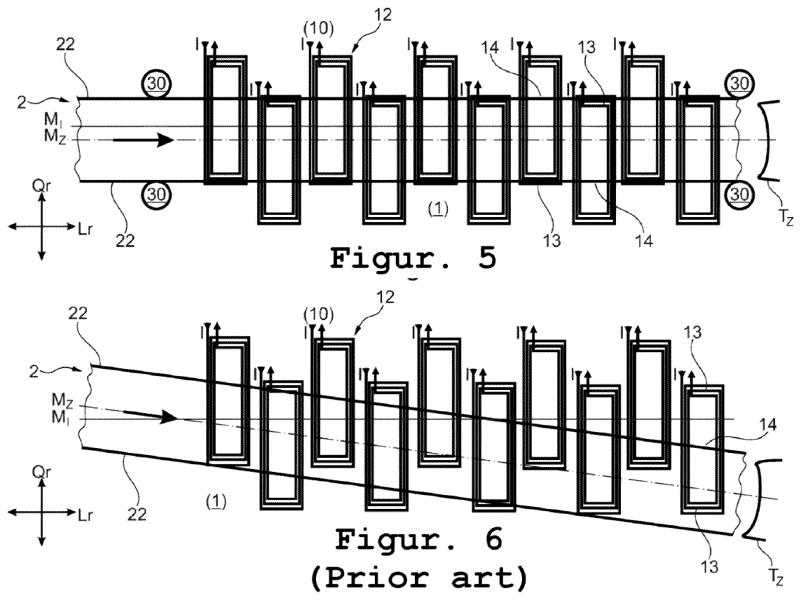

Because of the concept, cf. also FIGS. 3 and 4, one-sided local overheating of a (first) strip edge 22 (edge area 22) of an intermediate strip 2 (FIG. 1, overheating on the left) results in an induction furnace 1 due to an induction module head 12 (coil current I) of a single transverse field induction module 10. This overheating is caused by eddy currents due to an open middle area 14 of the induction module 10. The overheating of this first strip edge 22, due to a geometrical extension of the induction module head 12 in the transverse direction Or, is essentially independent in this case of a position of this induction module head 12 with respect to the intermediate strip 2, because this induction module head 12 protrudes beyond this first strip edge 22.

Cf. furthermore the temperature distributions T_{Z1} (dotted), T_{Z2} (solid), T_{Z3} (dashed), which illustrate a dependence of the temperature of the intermediate strip 2 on a position of the induction module head 12 in the transverse direction Qr over the intermediate strip 2. In this case, the temperature distribution T_{Z1} represents an induction module head 12 which protrudes over the second strip edge 22 (edge area 22) opposite to the first strip edge 22 (approximately +20 mm at a width of the intermediate strip 2 in the transverse direction Qr of approximately 1200 mm). Furthermore, the temperature distribution T_{Z2} represents an induction module head 12 in the correct position with respect to this second strip edge 22. And the temperature distribution T_{Z3} represents an induction module head 12 which does not extend close enough to the second strip edge 22 (approximately −20 mm in the above example).

In other words, the second strip edge 22 opposite with respect to the first strip edge 22 (FIG. 1, open middle section 14) in the transverse direction Qr heats up either essentially intentionally correctly (for induction modules 10 installed in pairs; cf. FIG. 1, solid line T_{Z2}). Or if the induction module head 12 does not extend up to this strip edge 22, underheating is obtained (cf. FIG. 1 right, dashed line T_{Z3}). And if the induction module head 12 extends beyond this strip edge 22, overheating is obtained analogously to an open middle area 14 (cf. FIG. 1 right, dotted line T_{Z1}).

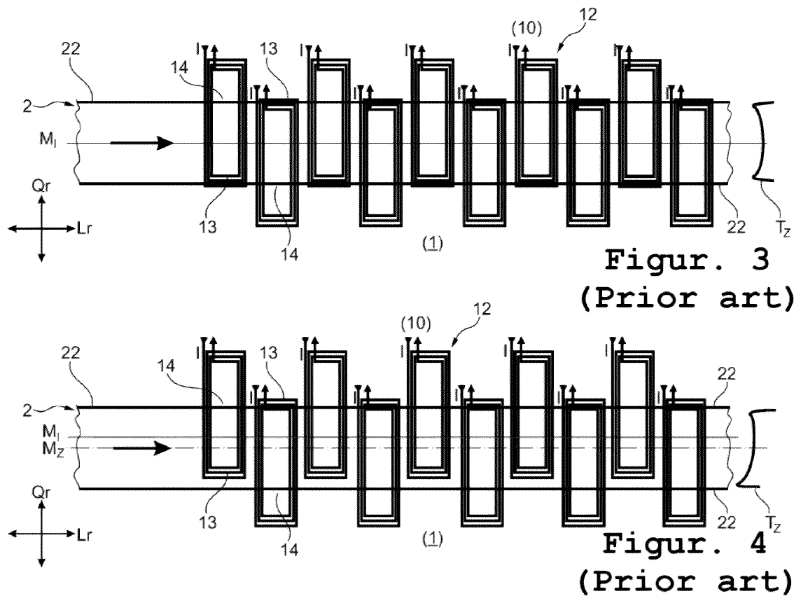

To counteract this and in the ideal case to obtain a symmetrical temperature distribution T_{Z} (analogous to thermal energy distribution T_{Z}) of the intermediate strip 2 (cf. FIG. 2), induction modules 10 are installed in pairs (see FIGS. 3 to 7). Therefore, each strip edge 22 of the intermediate strip 2 passes both a closed end area 13 and an open middle area 14 of two induction module heads 12 of two induction modules 10 arranged directly adjacent to one another or a plurality of such pairs (cf. FIG. 3: five such pairs). The strip edges 22 of the intermediate strip 2 are therefore heated essentially identically (cf. FIG. 2). In this case, an electrical power introduction into the intermediate strip 2 by means of the induction module heads 12 is essentially symmetrical.

A distance which an induction module head 12 has to the intermediate strip 2, thus its two strip edges 22, 22, decisively influences the temperature distribution T_{Z} of the intermediate strip 2 over its width, for example shown as a course line in the transverse direction Qr in FIGS. 1 and 2. FIG. 1 shows how the distance of an induction module 10 to the two strip edges 22, 22 of the intermediate strip 2 influences a power introduction (vertical axis: temperature distribution T_{Z}, for example in the form of a line power density, by specification of a temperature, etc.) into the intermediate strip 2 over a width (right axis: left strip edge 22 after induction furnace center line M_{I} after right strip edge 22) of the intermediate strip 2 in the transverse direction Qr.

The farther away an induction module head 12 thus is from the outer strip edge 22 for it (cf. the upper induction module heads 12 in FIG. 4), the lower the power introduction and as a further consequence the lower the temperature will be there (cf. the temperature distribution T_{Z} of the intermediate strip 2 in FIG. 4). In order to heat the two strip edges 22, 22 uniformly with respect to an intermediate strip center line M_{Z}, the induction modules 10 are therefore always installed in pairs. Cf. FIG. 2 on the right, which shows the result of an electrical power introduction with multiple induction modules 10 connected in pairs.

In this case, a first induction module head 12 heats a first strip edge 22 with its open middle area 14 and the second strip edge 22 opposite in relation thereto in the transverse direction Qr with its closed end area 13; cf., for example, the induction module head 12 in FIG. 3 at the very left. Antiparallel thereto, a second induction module head 12 heats the second strip edge 22 with its open middle area 14 and the first strip edge 22 opposite in relation thereto in the transverse direction Qr with its closed end area 13; cf., for example, the induction module head 12 in FIG. 3 on the right next to the induction module head 12 on the very left.

Mechanical positioning of the individual transverse field induction modules 10 takes place in the prior art, cf. FIG. 3, absolutely in relation to an induction furnace center line M_{I} of the rolling system, in the example mentioned at the outset thus the induction furnace center line M_{I} between the high-reduction rolling mill and the finishing rolling mill. However, the intermediate strip center line M_{Z} of the intermediate strip 2 is not always located on the induction furnace center line M_{I}, cf. FIG. 4. On this basis of the induction furnace center line M_{I}, however, the transverse field induction modules 10 and their induction module heads 12 are positioned in the prior art.

If the intermediate strip center line M_{Z} deviates from the induction furnace center line M_{I}, see FIG. 4, to which the induction module heads 12 refer, however, the above-discussed asymmetrical temperature distributions T_{Z} occur at the strip edges 22 of the intermediate strip 2 at the outlet of the induction furnace 1. The asymmetrical temperature distribution T_{Z} (FIG. 4 on the very right) can as a further consequence result in quality problems on the product and in process stability problems.

This problem can be solved by at least one of the following measures.—The actual or current intermediate strip center line M_{Z} is detected and used for the horizontal positioning of induction modules 10 or their induction module heads 12 (center line detection). Due to the positioning of the lateral guidance rollers 30 at the intermediate strip 2, for example, by means of a force regulation, the current intermediate strip center line M_{Z} of the intermediate strip 2 can be identified. Additionally or alternatively, the current intermediate strip center line M_{Z} can also be detected by another suitable center line detection (other unit or device on the intermediate strip 2, image processing, vision device/system, etc.).

The actual or current, in particular horizontal intermediate strip center line M_{Z} of the intermediate strip 2 is forwarded as a further consequence to a system controller (automation), for example, of the induction furnace 1. This positions the individual induction modules 10 or their induction module heads 12 in accordance with the detected and forwarded intermediate strip center line M_{Z}. The induction modules 10 or their induction module heads 12 can thus be positioned depending on the current intermediate strip center line M_{Z} and therefore a symmetrical temperature distribution T_{Z} can be achieved even with deviations of the center line M_{Z} of the intermediate strip 2 from the center line M_{I} of the rolling system (cf. FIG. 5 on the very right).

Therefore, on the one hand, deviations of the intermediate strip 2 in the transverse direction Qr (see FIG. 5, transverse direction deviation) and angular deviations of the intermediate strip 2 with respect to the intermediate strip center line M_{Z} (see FIG. 7, angle deviation) can be compensated.—FIGS. 3 to 7 essentially show a run (arrow, intermediate strip center line M_{Z}) of the intermediate strip 2 relative to the induction furnace center line M_{I}, a position of the induction module heads 12 and a temperature distribution T_{Z} (very right) of the intermediate strip 2 at the outlet of the induction furnace 1.

FIGS. 3 and 4 represent the prior art. Initially (FIG. 3), the intermediate strip 2 runs in the middle of the induction furnace 1, for example, of the rolling system. The induction module heads 12 are positioned symmetrically to a strip run of the intermediate strip 2 (induction furnace-fixed). Current positioning (randomly) corresponds to the desired or previously calculated positioning, since the intermediate strip center line M_{Z} coincides with the induction furnace center line M_{I}. A symmetrical temperature distribution T_{Z} thus results (FIG. 3 on the very right).

In FIG. 4, the intermediate strip 2 does not run in the middle of the induction furnace 1. The intermediate strip center line M_{Z} is not known to a system controller. The induction module heads 12 refer to the induction furnace center line M_{I}, due to which the induction module heads 12 are positioned asymmetrically at the intermediate strip 2. The previously calculated positioning does not correspond to current positioning, since the intermediate strip center line M_{Z} is different from the induction furnace center line M_{I}. An asymmetrical temperature distribution T_{Z} therefore results in the prior art.

In FIG. 5, the intermediate strip 2 also does not run in the middle of the induction furnace 1. The intermediate strip center line M_{Z} is currently known, however, due to positioning of the lateral guidance rollers 30 at the intermediate strip 2. In other words, the current intermediate strip center line M_{Z} can be determined by current positioning of the lateral guidance rollers 30.

The induction module heads 12 can now refer to the intermediate strip center line M_{Z} and are positioned accordingly. The induction module heads 12 are now positioned symmetrically at the intermediate strip 2 and no longer symmetrically at the induction furnace center line M_{I}. The calculated positioning corresponds to the current positioning, since now the intermediate strip center line M_{Z} is decisive for the positioning of the induction module heads 12 at the intermediate strip 2. A symmetrical temperature distribution T_{Z} of the intermediate strip 2 therefore results (FIG. 5 on the very right).

In FIG. 6 (prior art), the intermediate strip 2 does not run in the middle of the induction furnace 1, but rather at an angle thereto. The intermediate strip center line M_{Z} is not known. The induction module heads 12 refer to the induction furnace center line M_{I}, due to which the induction module heads 12 are positioned asymmetrically at the intermediate strip 2. The calculated positioning does not correspond to the current positioning, since the intermediate strip center line M_{Z} is different from the induction furnace center line M_{I}. An asymmetrical temperature distribution T_{Z} therefore results (FIG. 6 on the very right).

In FIG. 7, the intermediate strip 2 also does not run in the middle of the induction furnace 1, but rather again at an angle in relation thereto. The intermediate strip center line M_{Z} is known due to positioning of the lateral guidance rollers 30. The induction module heads 12 can now refer to the intermediate strip center M_{Z} and are positioned accordingly. The induction module heads 12 are now positioned symmetrically at the intermediate strip 2. The calculated positioning corresponds to the current positioning, since now the intermediate strip center line M_{Z} is decisive for the positioning of the induction module heads 12 at the intermediate strip 2. A symmetrical temperature distribution of the intermediate strip 2 T_{Z} therefore results (FIG. 7 on the very right).

Furthermore, see FIGS. 8 to 10, alternatively or additionally at the beginning, in a middle and/or at an end of the induction furnace 1 (FIG. 10), the current temperature distribution T_{Z} of the intermediate strip 2 can be detected, for example, by a temperature determination process, in particular a temperature scanner 40. This temperature distribution T_{Z} is used to position induction module heads 12 horizontally by means of a control method or a regulation method (closed-loop control: closed control circuit) and if possible to improve the temperature distribution T_{Z}. If it is recognized that the temperature distribution T_{Z} on one side of the intermediate strip 2 deviates from a norm, the induction module heads 12 are thus positioned such that a temperature distribution T_{Z} which is symmetrical if possible and is possibly uniform is obtained.

FIG. 8 shows such a deviation in the form of a temperature distribution T_{Z} of the intermediate strip 2 which is asymmetrical with respect to the intermediate strip center line M_{Z} along a line (transverse axis: 22 after M_{Z} after 22) in the transverse direction Qr on the surface of the intermediate strip 2. From this temperature distribution T_{Z}, a trend line Tr, in this case a linear trend line Tr, can be determined or calculated.—In this case, the trend line Tr can be determined or calculated in many different ways.

Simple forms are, for example, connecting the absolute minima or the absolute maxima of the temperature distribution T_{Z} of the intermediate strip 2. Furthermore, a possibly weighted mean of two such connecting lines can be used as the trend line Tr. The areas of the intermediate strip 2 which end with the strip edges 22 can receive special weighting. Trend lines Tr of higher order, thus for example nonlinear trend lines Tr, are also applicable, of course.

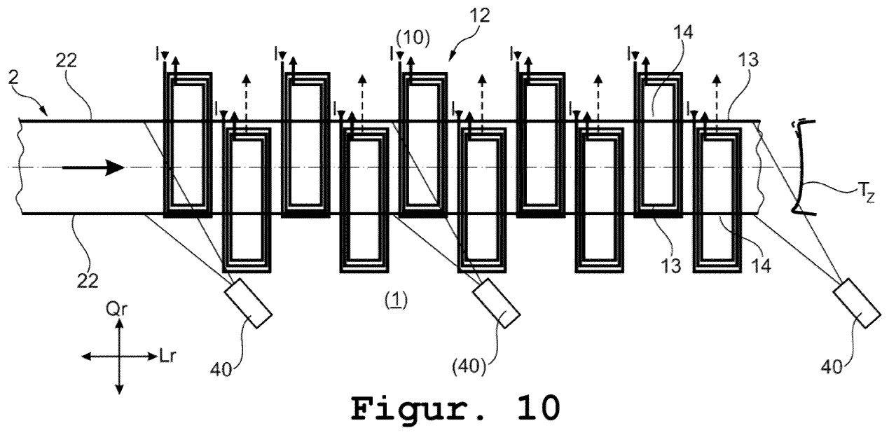

A horizontal alignment of induction module heads 12 is now changed by the control method or the regulation method such that the trend line Tr if possible lies close to a predetermined essentially good to optimum solution, also represented by a trend line Tr (FIG. 9). In the present case, in the illustrated example of the linear trend lines Tr, a slope of the essentially good to essentially optimum trend line Tr is zero (trend line Tr essentially parallel to the right axis). The current trend line Tr is to approximate this slope and if possible is to coincide therewith.

For this purpose, of course, preferably only those induction module heads 12 are horizontally adjusted (positioned), using which an improvement of the trend line Tr can be implemented. These are normally at most half of all existing induction module heads 12, namely those which are located with their closed end areas 13 at (above/below) a cold strip edge 22. Of course, it is possible to adjust the induction module heads 12 in pairs, for example by the same absolute value, since a displacement of an open middle area 14 of an induction module head 12 has no significant effects on a temperature of the strip edge 22.

As shown in FIG. 10, a determination of a temperature distribution T_{Z} (thermal energy distribution T_{Z}) of the intermediate strip 2 in the transverse direction Qr can be carried out before the induction furnace 1, for example, by a temperature scanner 40 (on the left in FIG. 4). The signal of this temperature scanner 40 is used to determine a required electrical power of the induction modules 10 or the induction module heads 12 of the induction furnace 1, a required electrical power distribution within the induction furnace 1 on the induction modules 10 or the induction module heads 12 thereof and the required positions of the induction module heads 12 in the transverse direction Qr above/below the intermediate strip 2 by way of a suitable model, so that a desired temperature and a symmetrical temperature distribution T_{Z} is implementable within permitted limits.

In addition to a required energy introduction (if possible symmetrical and possibly uniform) into the intermediate strip 2, for example for finish rolling of the intermediate strip 2, in this way compensation of an asymmetrical temperature distribution of the intermediate strip 2 chronologically after rolling and before the heating of the intermediate strip 2 in the induction furnace 1 by the induction furnace 1 can already be planned. In other words, the relevant induction module heads 12 can initially be supposed to be intended to be positioned such that a recognized asymmetry of the incoming temperature distribution T_{Z} of the intermediate strip 2 can be compensated.—Of course, the positioning of the induction module heads 12 can then be further changed by a method according to the invention such that a recognized asymmetry of the outgoing temperature distribution T_{Z} of the intermediate strip 2 can additionally or primarily be compensated.

A determination of the temperature distribution T_{Z} of the intermediate strip 2 in the transverse direction Qr at an outlet or a rear end of the induction furnace 1 can also typically be carried out by a temperature scanner 40 (on the right in FIG. 10). If, as described above, an asymmetry of the temperature distribution T_{Z} is established or measured in this measurement, and, for example, a non-horizontal trend line Tr is calculated, a correction can then be carried out. The correction relates in particular to a compensation of an asymmetrical temperature distribution of the intermediate strip 2 due to a deviation of the intermediate strip center line M_{Z} from an induction furnace center line M_{I} for a chronologically subsequent longitudinal section of the intermediate strip 2 in the induction furnace 1.

This is carried out, for example, as indicated in FIG. 10, in that the induction module heads 12 which are positioned on a colder strip edge 22 are moved further in the direction of the colder strip edge 22 (dashed arrows). This also causes, as shown in FIGS. 8 and 9, an increased concentration of magnetic fields/eddy currents in the intermediate strip 2 on this side in the intermediate strip 2 and therefore causes a higher strip edge temperature (see dashed line in the temperature distribution T_{Z} of FIG. 10).

This can be carried out by a control/regulation, wherein the induction module heads 12 are moved far enough until the determined temperature distribution T_{Z} is symmetrical again; for example, the trend line Tr becomes horizontal. A calculation model for an equalization of the temperature asymmetry can preferably calculate a required shift of these induction module heads 12 beforehand and the induction module heads 12 can be positioned according to these calculated offsets, which results in reaching a symmetrical temperature distribution T_{Z} in the intermediate strip 2 faster.

With additional consideration of an incoming temperature distribution T_{Z}, the calculation model can calculate positioning of possibly all induction module heads 12, i.e. those identified in FIG. 10 by the dashed arrows and their complementary induction module heads 12 (in the pairs of induction modules 10). Therefore, essentially all requirements with respect to power consumption, making symmetrical and possibly making uniform the temperature distribution T_{Z} and equalizing temperature asymmetries can be calculated essentially at any time in the method and can be repeatedly predetermined as new target values for the control/regulation of the induction furnace 1.

Furthermore, the temperature distribution T_{Z} and therefrom the trend line Tr can additionally also be determined at a further position (middle temperature scanner 40 in FIG. 10). Therefore, subsequent induction module heads 12 after the middle temperature scanner 40 can be used for the control/regulation of a symmetrical temperature distribution T_{Z}.—The method can operate both with the incoming temperature scanner 40 as the single temperature scanner 40 and also the outgoing temperature scanner 40 as the single temperature scanner 40. Of course, both temperature scanners 40, 40 are also usable. The middle temperature scanner 40 (in parentheses in FIG. 10) can be used in all exemplary embodiments, but can also be omitted.

1. A method for heating, in particular reheating, an intermediate strip when producing a flat strip, wherein
the intermediate strip is heated by induction module heads of induction modules of an induction furnace, in particular of a rolling system, preferably of a steel strip production system, wherein
the induction module heads are mechanically positioned according to at least one current parameter of the intermediate strip at/in the induction furnace such that
at at least one position in/at the induction furnace in the transverse direction (Qr) at/in the intermediate strip with respect to the intermediate strip center line (M_{Z}), a thermal energy distribution (T_{Z}) of the running intermediate strip which become symmetrical over time results.

2. The method as claimed in claim 1, wherein according to the at least one parameter of the intermediate strip, in the chronological sequence at the at least one position in/at the induction furnace, the following is intentionally attempted by the positioning of induction module heads:
to obtain this thermal energy distribution (T_{Z}) of the intermediate strip in its preliminary symmetry or to make this preliminary symmetry more symmetrical,
to even out this thermal energy distribution (T_{Z}) of the intermediate strip in the transverse direction (Qr) at/in the intermediate strip, and/or
to equalize thermal energy of a strip edge of the intermediate strip to thermal energy of the intermediate strip center line (M_{Z}).

3. The method as claimed in claim 1, wherein the parameter of the intermediate strip
reflects an essentially current statement about the current intermediate strip at/in the induction furnace and/or at/in the rolling system, and/or
does not represent a merely general statement about the induction furnace itself and/or the rolling system itself.

4. The method as claimed in claim 1, wherein the parameter of the intermediate strip:
does not reflect an exclusively geometric statement about the induction furnace itself and/or the rolling system itself,
does not reflect a center line (M₁) or a transverse boundary of the intermediate strip in the induction furnace itself and/or in the rolling system itself,
reflects a geometric location of the intermediate strip within the rolling system and/or the induction furnace, and/or
reflects a thermal energy distribution (T_{Z}) of the intermediate strip in the transverse direction (Qr) of the intermediate strip at/in the rolling system and/or at/in the induction furnace.

5. The method as claimed in claim 1, wherein the parameter of the intermediate strip reflects the intermediate strip center line (M_{Z}) in the induction furnace, wherein:
a different value, in particular a different current measured value, is incorporated in the parameter of the intermediate strip,
a current thermal energy distribution (T_{Z}) of the intermediate strip is incorporated in the parameter of the intermediate strip,
the parameter of the intermediate strip essentially exclusively represents the intermediate strip center line (M_{Z}), and/or
the intermediate strip center line (M_{Z}) is detected by a center line detection process.

6. The method as claimed in claim 1, wherein:
the intermediate strip center line (M_{Z}) in the induction furnace is determined from current positioning of precisely/at least one, precisely/at least two or precisely/at least four lateral guidance rollers at the intermediate strip,
current positioning of a lateral guidance roller is taken/obtained from a force regulation of the lateral guidance roller, and/or
a parallel and/or an angled current offset of the intermediate strip center line (M_{Z}) in relation to the induction furnace center line (M_{I}) is determined from current positioning of lateral guidance rollers.

7. The method as claimed in claim 1, wherein the parameter of the intermediate strip reflects a thermal energy distribution (T_{Z}) of the intermediate strip at/in the induction furnace, wherein:
a different value, in particular a different current measured value, is incorporated in the parameter of the intermediate strip,
a current intermediate strip center line (M_{Z}) is incorporated in the parameter of the intermediate strip,
the parameter of the intermediate strip essentially exclusively represents the thermal energy distribution (T_{Z}) of the intermediate strip, and/or
the thermal energy distribution (T_{Z}) of the intermediate strip (T_{Z}) is detected by a temperature determination process, in particular a temperature scanner.

8. The method as claimed in claim 1, wherein the current thermal energy distribution (T_{Z}) of the intermediate strip is determined in the transverse direction (Qr), and
from the thermal energy distribution (T_{Z}), a current trend line (Tr) is determined, which reflects a current degree of symmetry of the thermal energy distribution (T_{Z}) of the intermediate strip in the transverse direction (Qr), wherein
on the basis of this current trend line (Tr), induction module heads of the induction furnace are positioned such that the current degree of symmetry of the thermal energy distribution (T_{Z}) of the intermediate strip-becomes symmetrical or at least does not become symmetrical in the transverse direction (Qr).

9. The method as claimed in claim 1, wherein an incoming, current thermal energy distribution (T_{Z}) of the intermediate strip in the transverse direction (Qr) is determined before the actual and/or in the front induction furnace, wherein from this thermal energy distribution (T_{Z})
a required electrical power of the induction furnace, a required electrical power distribution within the induction furnace (and/or a required position of induction module heads in the transverse direction (Qr) is determined, wherein
the induction module heads are preferably initially supposed to be intended to be positioned such that an incoming asymmetry of a temperature distribution (T_{Z}) of the incoming intermediate strip into the induction furnace is compensated.

10. The method as claimed in claim 1, wherein an outgoing, current thermal energy distribution (T_{Z}) of the intermediate strip in the transverse direction (Qr) is determined in the rear and/or after the actual induction furnace, wherein from this thermal energy distribution (T_{Z})
a current trend line (Tr) is determined, which reflects a current degree of symmetry of the thermal energy distribution (T_{Z}) of the intermediate strip in the transverse direction (Qr), and the induction module heads are positioned on the basis of the trend line (Tr) such that an asymmetry of a temperature distribution (T_{Z}) of the outgoing intermediate strip is compensated, wherein
preferably an incoming, current thermal energy distribution (T_{Z}) of the intermediate strip in the transverse direction (Qr) is taken into consideration.

11. The method as claimed in claim 1, wherein the method is operated such that a current trend line (Tr) of a current thermal energy distribution (T_{Z}) of the intermediate strip approximates a desired trend line (Tr)

12. A system controller for an induction furnace, a rolling system or a steel strip production system, in particular for endless strip production, wherein
a method as claimed in claim 1 can be carried out and/or is carried out by the system controller.

13. An induction furnace, a rolling system or a steel strip production system, in particular for endless strip production, wherein the induction furnace, the rolling system or the steel strip production system has induction module heads, wherein
the induction furnace, the rolling system or the steel strip production system has a system controller as claimed in claim 12.

14. An induction furnace, a rolling system or a steel strip production system, in particular for endless strip production, wherein characterized in that the induction furnace, the rolling system or the steel strip production system has induction module heads, wherein a method as claimed in claim 1 can be carried out and/or is carried out by the induction furnace, the rolling system or the steel strip production system.
